(19) United States
(12) Patent Application Publication
(10) Pub. No.: US 2009/0043686 A1
(43) Pub. Date: Feb. 12, 2009

(54) Processing arrangements for biomass byproducts and biomass derivative products

(75) Inventor: Yoshimasa Matsumoto, Decatur, IL (US)

Correspondence Address: K&L GATES LLP;HENRY W. OLIVER BUILDING, 535 SMITHFIELD STREET, PITTSBURGH, PA, 15222, US

(73) Assignee: Archer-Daniels-Midland Company

(21) Appl. No.: 11/891,412

(22) Filed: Aug. 10, 2007

(51) Int. Cl. G06Q 30/00; G06Q 40/00; G06Q 90/00

(52) U.S. Cl. 705/37; 705/1

(57) ABSTRACT

Various arrangements are disclosed wherein biomass processing services are provided to a producer of an agricultural product. One such arrangement may include the producer paying a fee or offering biomass related products to a buyer in exchange for receiving the biomass processing services. At least a portion of the fee for providing the biomass processing services may be paid by delivery of a quantity and/or quality of agricultural products, biomass byproducts, or biomass derivative products. In certain embodiments, arrangements between the producer and the buyer may also involve establishing vendor credit accounts or providing other financing programs to the producer.

### FIELD OF THE INVENTION

The invention generally relates to establishing arrangements between producers of agricultural and biomass related products and buyers for such products. In certain embodiments, the invention more particularly relates to arrangements that involve providing biomass byproducts and/or biomass derivative products in exchange for receiving biomass processing services.

### BACKGROUND

In a world of limited resources, it is important to consider options for recycling or reusing byproducts that arise from primary processing of materials used in commercial production.

In the context of agricultural production, for example, it is important to consider potentially beneficial uses for waste material and other biomass related products derived from primary production of agricultural products. One problem that limits effective collection and use of waste materials and other biomass byproducts is the lack of a viable market for buying and selling such products. For example, there is presently no large-scale commercial biomass market that could serve as a central meeting point for producers such as farmers who generate significant amounts of biomass byproducts in their fields and buyers interested in reusing or recycling the biomass byproducts. A primary obstacle preventing development of a viable commercial biomass market is the initial capital investment that producers would need to undertake to purchase biomass processing equipment necessary for collecting, processing and storing the biomass byproducts. Also, many producers do not have financial resources sufficient to fund the costs of transporting and selling the processed biomass byproducts to potential buyers.

In view of the foregoing issues, more effective and efficient arrangements, strategies, processes, financial products and/or structures are needed to reap the benefits of reusing or recycling the byproducts of agricultural production.

### BRIEF DESCRIPTION OF THE DRAWINGS

The embodiments of this invention, and the manner of obtaining its many benefits and advantages, will become apparent and understood by reference to the following description taken in conjunction with the accompanying drawings, wherein:

FIG. 1 includes a schematic architecture illustrating various examples of arrangements that may be provided in association with embodiments of the invention;

FIG. 2 includes a process flow diagram illustrating an example of a process that may be performed in connection with the architecture of FIG. 1;

FIG. 3 includes a schematic architecture illustrating various examples of arrangements that may be provided in association with embodiments of the invention;

FIG. 4 includes a process flow diagram illustrating an example of a process that may be performed in connection with the architecture of FIG. 3;

FIG. 5 includes a schematic architecture illustrating various examples of arrangements that may be provided in association with embodiments of the invention;

FIG. 6 includes a process flow diagram illustrating an example of a process that may be performed in connection with the architecture of FIG. 5; and,

FIG. 7 includes a schematic architecture illustrating various communications which may be conducted in association with embodiments of the invention.

Corresponding reference characters indicate corresponding parts throughout the several views. It can be appreciated that the drawings illustrate various examples of embodiments of the invention, but such examples are not to be construed as necessarily limiting the scope of the invention.

### DESCRIPTION

As applied herein, the term “agricultural product” includes any product produced through agricultural activity which is capable of generating a biomass byproduct (as defined below). Non-limiting examples of agricultural products include grains such as wheat, corn, barley, rice, sorghum, or other grasses or monocot plants that can be harvested for food or feed; horticultural crops such as non-grain or dicot plants that produce food; arboreal crops, such as trees; and/or, soy beans, cotton, rape, canola, cocoa, palm, fruits, vegetables, timber, or agricultural commodities or products of farming activity. Future energy crops, whether genetically modified or not, are also included. Non-limiting examples of future energy crops include switch grass and poplar. Also included in the definition of “agricultural products” are products or byproducts derived from livestock (e.g., cattle, sheep, or horses), including meat, fur, pelts, or other products of animal origin.

The term “biomass byproduct” includes any leftover matter, waste product, or other secondary byproduct obtained incident to “primary processing” of an agricultural product. The “primary processing” of an agricultural product means a process or processes used to produce an article of commerce obtained directly from the agricultural product. Examples of “biomass byproducts” from plant agriculture include, without limitation, corn stalks, straw from wheat, wood chips remaining after producing wood construction materials (e.g., sawmills or lumber yards), residual plant materials such as husks, shells, stems, roots, leaves, or cores, process byproducts such as soybean hulls, corn dust, cellulosic fibers, cellulose, paper millings (e.g., from waste or recycled papers), distiller's dry grain, soybean meal, corn gluten feed, corn gluten meal, vegetable oil soap stocks, tall oil, wood chips and wood pulps. Examples of “biomass byproducts” from processing or cultivating livestock include, without limitation, manure, used straw, tallow, used animal fats, spoiled meat, blood and the like.

The term “biomass derivative product” includes any product created by processing an agricultural product or a biomass byproduct with a biomass processing service (as defined below). Examples of “biomass derivative products” include, without limitation, pyrolysis oil; synthetic gases, such as methane, and derivatives, such as hydrogen; alcohols such as ethanol, propanol, butanol and pentanol; mixed alcohols; waxes; green diesel; olefins such as propylene and ethylene; green gasoline; C3 and longer carbon chain chemicals; aldehydes; formaldehyde; MTBE; acetic acids; methanol; polyols; tar; and, animal feed comprised of biomass byproducts with conventional animal feed ingredients (e.g., corn stalk fiber combined with corn gluten to enhance fiber content of the corn gluten).

For convenience of disclosure and discussion of the various embodiments of the invention, the terms “biomass byproducts” and “biomass derivative products” may be collectively referred to herein sometimes as “biomass related products” or an equivalent term.

The term “biomass processing service” includes services which can be applied to agricultural products, biomass byproducts and/or biomass derivative products and/or permitting use of or providing access to “biomass processing equipment” to process or generate biomass related products. The provided service may also include chemical or thermal conversion of biomass to produce a gas, liquid or solid product. Examples of service-type “biomass processing services” that can be applied to agricultural products or biomass related products include, without limitation, collecting the products (e.g., collecting corn stalk and wheat shafts from fields); transporting products from a production site to a collection site; blending the products; pyrolyzing or gasifying the products; burning or combusting the products; pelletizing the products; shredding the products; hydrothermal upgrading the products; hydrocracking, hydrotreating or refining the products; baling the products; storing the products; renting or leasing a piece of “biomass processing equipment” to or on behalf of producers; consulting with producers on growing, handling, processing, or storing the products; and many other types of services that involve processing biomass. Non-limiting examples of “biomass processing equipment” include transporters, pyrolysis units, combines, gasifying units, burners or combustors, pelletizers, shredders, hydrothermal processors, refineries, hydrocrackers, hydrotreaters, balers, and storage tanks, among many others. Such equipment may be mobile and/or stationary when applied to processing agricultural products and/or biomass related products.

A “producer” means any entity that produces agricultural products or biomass related products, and/or which is capable of using biomass processing services or biomass processing equipment. Non-limiting examples of “producers” include farmers, farm cooperatives, corporate farming businesses, grain elevators, governmental entities, and many other entities.

The term “agriculturally related purpose” includes purposes that relate to the production, development, generation, maintenance, storage, or supply of agricultural products, biomass byproducts, and/or biomass derivative products. For example, funds or credits applied to an “agriculturally related purpose” by a producer may be spent on biomass processing services, biomass processing equipment, seed, fertilizer, crop protection, equipment repair and maintenance costs, bin building, storage facility construction, and/or capital expenditures for new planting or harvesting equipment, among many other types of such purposes.

The term “commodity” may include an agricultural product, a biomass byproduct, a biomass derivative product, a biomass related product, other commodities, and/or any reasonable combination thereof.

A “cash commodity contract” is any type of contract between a buyer and seller for sale and purchase of a commodity.

A “short call option” is a commodity trading contract that gives a buyer the right to purchase a futures contract for a designated amount of the commodity at a designated price by a specified expiration date.

A “corresponding futures contract” means an option for a futures contract for the same quantity and type of commodity that is the subject of a cash commodity contract.

The term “alliance partner” is used herein to designate an entity that has agreed with the commodity buyer to provide goods or services to a producer in a second business transaction not directly related to a first business transaction between the commodity buyer and the producer and has agreed to accept at least a portion of payment from the commodity buyer for goods or services purchased by the producer. An alliance partner may be the same entity as the commodity buyer or an affiliate thereof in cases where the commodity buyer is an entity that not only buys commodities from the producer in a first transaction, but also provides other goods or services that the producer may desire in a second transaction.

As used herein, “settling” such as with respect to “settling the commodity contract” means taking delivery of a commodity by a buyer and paying the seller of the commodity or the producer, wherein at least part of the payment may include a fee for using or accessing a biomass processing service.

As used herein, an “offsetting options contract” is a second option contract that takes the opposite position of a first option contract with respect to whether the option is to buy or sell a given amount of a commodity.

The term “basis” is well understood in the art of commodity trading to have ordinary and specific meanings that vary only by the particular types of parties and particular types of transactions involved in trading commodities. All the ordinary meanings are embraced herein. Most generally, a “basis” is the difference in price between an accepted index, such as for example the futures price for a particular commodity at any given moment, and the price being offered to exchange, or obtain a right to exchange, that commodity at the same moment. Thus, for example, the basis between a buyer and seller of the commodity for future delivery is the difference between the futures price for that commodity at the time of the contemplated trade and the amount the buyer is willing to offer to purchase the commodity. The basis is the difference between the forward contract and the amount paid at delivery.

Embodiments of the invention may involve establishing arrangements between producers of agricultural products and buyers interested in purchasing such products and/or entities that offer biomass processing services. For example, the buyer may also be a biomass service provider which provides biomass processing services, biomass processing equipment, and/or instructions or consulting services to the producer in association with collecting, storing, processing or transporting biomass byproducts and biomass derivative products. In certain embodiments, the buyer may desire to purchase one or more of the agricultural products, biomass byproducts, and/or biomass derivative products for delivery at a specified location at a predetermined time, quality and quantity. From a user perspective, the arrangement may involve accessing or using biomass processing services or biomass processing equipment provided by the buyer in exchange for the value of agricultural products and/or biomass related products delivered to the buyer. In certain embodiments, valuations of the agricultural products and/or biomass related products may be based on relevant local market pricing, a market index, a futures price, energy market pricing, and/or by another suitable valuation method. In addition, the value of the delivered products may be used to offset or pay for the value of biomass processing services or biomass processing equipment provided to the producer by the buyer.

In certain embodiments, the producer and the buyer or biomass service provider may barter to exchange biomass related products and/or agricultural products for goods or services such as food, energy, loan interest rate reduction, greenhouse gas credits, grain basis and energy basis. Such a bartering mechanism can substitute for currency, for example, in situations where currency based trading may not be favorable for one or both of the parties. For example, in an African-based biomass market, producers may want to receive food and energy in exchange for biomass related products instead of cash. In such markets, it can be appreciated that application of embodiments of the invention might not only increase the use of biomass related products as an energy source but could also increase the income level of producers such as farmers.

In one example of the application of certain embodiments of the invention, a grain elevator operator rents biomass collection, storage, processing and transportation services and biomass processing equipment to local farmers and cooperatives of farmers. Under this arrangement, the farmers deliver agricultural products and biomass related products (which are collected, stored, processed and transported by the grain elevator operator) in exchange for payment made by the grain elevator operator based on the value of the agricultural products and biomass related products. Payments made by the grain elevator operation may be discounted or offset, at least partially, by the value of the biomass processing services provided to the farmers. Also, the farmers may have an option under the arrangement to deliver (at a specified date, time, quality and/or location): (i) agricultural products; (ii) biomass byproducts; (iii) biomass derivative products; or, (iv) some reasonable combination of agricultural products and biomass related products.

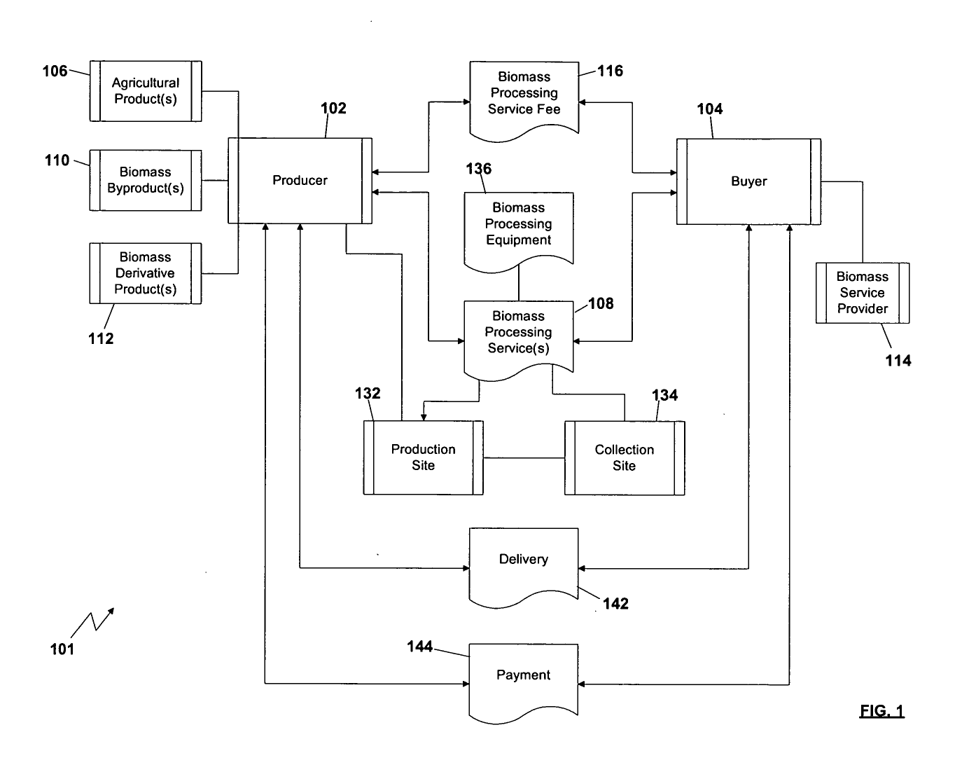

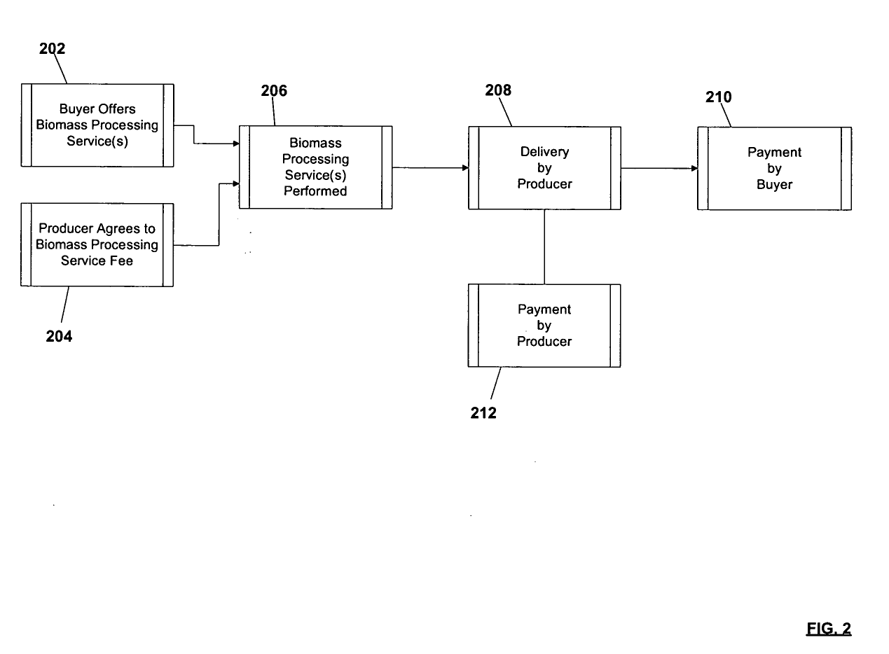

FIGS. 1 and 2 illustrate an example of an arrangement 101 or contract that can be established and conducted between a producer 102 of an agricultural product 106 and a buyer 104 in accordance with certain embodiments of the invention. At step 202, the buyer 104 may offer one or more biomass processing services 108 to the producer 102. Such biomass processing services 108 may involve processing biomass byproducts 110 derived from production of the agricultural product, and/or processing the biomass byproducts 110 to develop or generate biomass derivative products 112. In certain embodiments, the buyer 104 may directly offer the biomass processing services 108 to the producer 102 and/or may employ a third party biomass service provider 114 to provide the services 108.

At step 204, in exchange for offering the biomass processing services 108, the buyer 104 receives a promise from the producer 102 to pay a fee 116 or something of value for the biomass processing services 108 provided or performed by the buyer 104. In various embodiments, at least a portion of the fee 116 charged for the biomass processing services 108 may be paid by delivery of quantities of one or more of the following to the buyer 104: agricultural products 106; biomass byproducts 110 derived from the agricultural products 106; and/or, biomass derivative products 112. Under the arrangement established between the producer 102 and the buyer 104, delivery of such products 106, 110, 112 may occur at a specified time, date, or place and at a certain predetermined quantity or level of quality. Also, in certain embodiments, the third party biomass processing service provider 114 may be employed in association with the buyer 104 to provide or perform the biomass processing services 108 for the producer 102.

As the producer 102 conducts its activities with respect to producing agricultural products 106 and biomass byproducts 110, the biomass processing services 108 may be performed by or for the producer 102 at step 206. For example, the biomass processing services 108 may include transporting at least one of the biomass byproducts 110 or the biomass derivative products 112 from a production site 132 for the agricultural product to a collection site 134. At the collection site 134, the biomass related products 110, 112 may be processed in a piece of biomass processing equipment 136, such as a mobile pyrolysis unit, for example. In this example, the biomass byproduct 110 may include corn stalks, for example, generated as the result of harvesting and husking a crop of corn 106 grown by a farmer 102. The corn stalks 110 may be loaded into the mobile pyrolysis unit 136 and rendered into pyrolysis oil as a type of biomass derivative product 112. The pyrolysis oil 112 may then be transported to a-gasifying plant to be made into different types of alcohol, for example. The pyrolysis oil 112 may also be further refined into heating or cooking oil, for example, or another type of fuel oil.

It can be seen that the biomass processing services 108 may include loaning or leasing biomass processing equipment 136, such as the mobile pyrolysis unit, to the producer 102. The mobile pyrolysis unit 136 may be embodied as an apparatus which can be hauled by a comparatively larger truck, ship or other vehicle for transportation to the collection site 134.

At step 208, the producer 102 makes a delivery 142 of quantities of agricultural products 106 and/or biomass related products 110, 112 to the buyer 104. In connection with the delivery 142, the buyer 104 may make a payment 144 to the producer 102 at step 210 in the form of a cash amount or other consideration for the value of the products 106, 110, 112 included in the delivery 142. In addition, at step 212, the payment 144 may include amounts paid in cash or other consideration from the producer 102 to the buyer 104, such as to cover at least a portion of the biomass processing service fees 116, for example. The payment 144 may include an offset or discount that accounts for at least a portion of biomass processing service fees 116 which may be owed to the buyer 104. For example, such a biomass processing service fee 116 may include a rental fee for use of a mobile pyrolysis unit used by the producer 102. In certain embodiments, the delivery 142 may include one or more of agricultural products 106, biomass byproducts 110, or biomass derivative products 112 at a predetermined time and location. Also, the payment 144 may involve the buyer 104 paying the producer 102 for delivery of only agricultural products 106 with a predetermined extra quantity of agricultural products 106 in lieu of delivery of biomass related products 110, 112. In certain embodiments, at least a portion of the payment 144 between the producer 102 and the buyer 104 may include at least one bartered good or service including, for example and without limitation, agricultural products, food, energy, loan interest rate reduction, loan payment reduction, loan principal balance reduction, greenhouse gas credit, grain basis, energy basis, and/or other products or services. The value of the delivery 142 may be determined by pricing at least one of the delivered agricultural products 106, biomass byproducts 110, or biomass derivative products 112 by using a local market price, a biomass (or commodity) market index, an energy market index, and/or a futures price. For example, the biomass market index may be based, at least in part, on British Thermal Units (BTUs).

It can be seen that various alternatives may be offered to the producer 102 under the arrangement 101. In one alternative, the producer 102 may accept biomass processing services 108 or biomass processing equipment 136 from the buyer 104 in exchange for payment 114 including a rental fee. At least part of the rental fee can be paid as a discount or offset of the value of agricultural products 106, biomass byproducts 110, and/or biomass derivative products 112 delivered to the buyer 104 under the arrangement 101. This alternative may reduce the cash resources that the producer 102 might otherwise need to commit to rent or use the biomass processing equipment 136, for example. In another alternative, the producer 102 may be permitted to use the biomass processing equipment 136, or access other biomass processing services 108, at no cost in exchange for a promise to deliver all biomass byproducts 110 and/or biomass derivative products 112 generated by the producer 102 in a specified time period. In another alternative, the producer 102 may substitute an extra amount of agricultural products 106 to offset an amount of biomass related products 110, 112 not delivered to the buyer 104 with the delivery 142.

In view of the foregoing, embodiments of the invention may develop option pricing and other markets for biomass byproducts 110 and/or biomass derivative products 112. Those skilled in the art will see that such markets and pricing may arise due to a differential between the collected biomass related products 110, 112 versus the agricultural products 106. One problem that certain embodiments of the invention address is the typically large volume but low density of agricultural products 106 such as bailed wheat, for example. The substantial transportation costs associated with transporting high volume, low density products 106, 110, 112 may not be counterbalanced by the revenue derived from processing the products 106, 110, 112, because the yield of biomass related products 110, 112 is primarily a function of density. As noted in the examples discussed above, a reduction in transportation costs can be realized in the form of using mobile pyrolysis units as biomass processing equipment 136 at the production site 132 or the collection site 134 to alleviate the need to transport the products 106, 110, 112 over significant distances.

In association with the embodiments of the invention described above, one or more financial incentives or financial programs may be offered to the producer 102 in connection with delivering the agricultural products 106, biomass byproducts 110, and/or biomass derivative products 112 under various alternative arrangements (examples of which are described below).

In various embodiments, embodiments of the invention may be coupled with financial transactions, programs, tools, structures and systems in connection with a commodity contract between a producer and a buyer, examples of which are disclosed in the commonly assigned, pending U.S. patent application entitled, “Producer Financing in connection with Commodity Contracts” filed on Aug. 1, 2006, Ser. No. 60/834,631, the entirety of which is incorporated herein by reference. Embodiments of the invention can be designed to address the marketing and financial needs of producers. In various embodiments, the producer is permitted to access credit arrangements involving monetary loans, lines of credit, and/or other credit instruments to address financial needs associated with agriculturally related purposes. The credit arrangement can be facilitated, managed, and/or serviced by the buyer. In addition, repayment of the credit arrangement may occur in association with settlement of the commodity contract, such as when the producer delivers an amount of the commodity to the buyer in accordance with the contract. Also, the producer may be allowed to choose one of several commodity contract alternatives offered by the buyer, while receiving the credit arrangement in connection with the contract.

It is beneficial that repayment of the credit arrangement can be driven by market opportunities of the producer, instead of by a fixed date of maturity. This allows the producer to make business decisions based on the market, rather than on the timing of cash flow needs such as a loan repayment or product discount, for example. By assisting producers with the operation of their businesses, buyers can more effectively originate commodities for their own commercial needs. Embodiments of the invention may be coupled to various marketing tools or strategy alternatives employed by producers. For example, the invention may be applied in association with a portfolio approach to commodity marketing or other similar strategies that promote diversification in marketing commodities. The invention may eliminate or reduce “cash needs” marketing strategies for selling commodities, in which payments are due at fixed dates and/or prepayment is required.

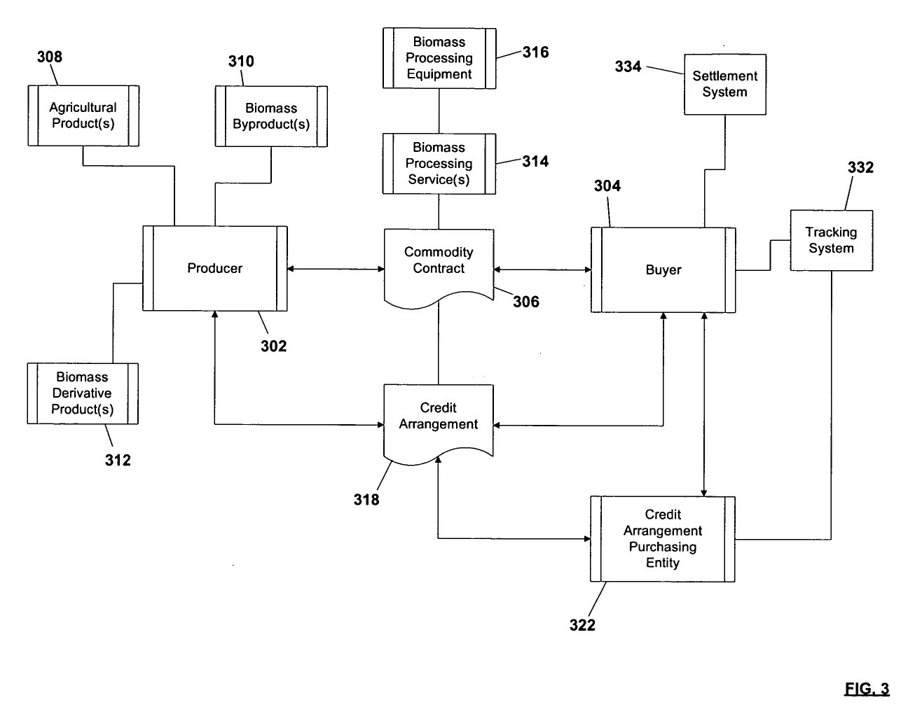

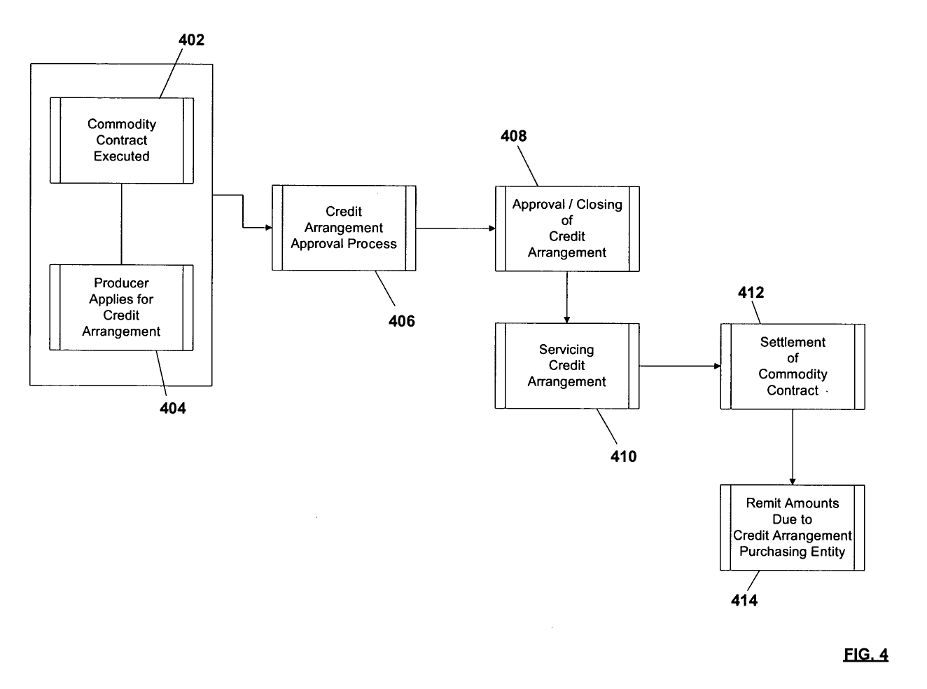

With general reference to FIGS. 3 and 4, in various embodiments of the invention, at step 402 a producer 302 enters into or executes a contractual arrangement or commodity contract 306 with a buyer 304 for production and delivery of agricultural products 308 and/or biomass related products 310, 312 to the buyer 304 at a future date or dates, and at a price or prices. The contract 306 may involve one or more different delivery dates during the life of the contract 306. Non-limiting examples of different commodity contracts 306 include an “ADM Advantage” contract; an average seasonal price or “ASP” contract; a basis contract; a deferred price contract; a forward purchase contract; a floor price contract; a hedge to arrive (“HTA”) or futures only contract; a minimum price contract; a min/max contract; a storage contract; a “bushels only” contract; a reasonable combination of two or more of the foregoing types of contracts; or, another type of commodity contract suitable for application to various embodiments of the invention. In accordance with embodiments of the invention described above, the contract 306 may also include terms or conditions under which biomass processing services 314 and/or biomass processing equipment 316 are offered to the producer 302 by the buyer 304.

At step 404, prior to or after (i.e., with respect to existing contracts) execution of the commodity contract 306, the producer 302 may apply to the buyer 304 to enter into a credit arrangement 318 associated with the contract 306. The credit arrangement 318 may be communicated or advertised to the producer 302 through a computer network (e.g., an Internet site). The credit arrangement 318 may also be communicated, for example, through direct mail advertising, direct contact between a representative of the buyer 304 and the producer 302, and/or through any other suitable non-electronic or non-electronic media. The contract 306 and credit arrangement 318 may also be offered to the producer 302 as a package to induce the producer 302 to do business with the buyer 304. To initiate the application process, the producer 302 may complete an application form, in either electronic or hard copy format. The application form may be posted on a web site, for example, of the buyer 304 and made accessible to different producers 302.

In various embodiments, the credit arrangement 318 may be a line of credit, loan, or other similarly structured financial arrangement that provides a source of funds for the buyer 304. For example, the credit arrangement 318 may be a revolving debt arrangement with a variable or fixed interest rate. The interest rate may be tied to an index or rate published by a trusted or credible source (e.g., the prime lending rate), and the interest rate can be a percentage of the published index or rate. For example, the interest rate for the credit arrangement 318 may be established at the prime rate plus two percentage points. In another example, the interest rate used for the credit arrangement 318 can be the prime lending rate set by the Federal Reserve Bank on the date the credit arrangement 318 is offered to the producer 302.

The credit arrangement 318 may also have a credit limit and other terms or features that can be considered and selected based on a number of risk factors ascribed by the buyer 304. For example, the interest rate and the credit limit offered with a particular credit arrangement 318 can be based on one or more ascribed risk factors, sets of risk criteria, and/or other factors that can be applied by the buyer 304 in assessing financial risks associated with the offered credit arrangement 318. Thus, it can be seen that the credit arrangement 318 can be offered, with terms such as interest rate and credit limit, in connection with an assessment of one or more risk factors ascribed by the buyer 304 to the aspects of a particular scenario involving a given type of commodity contract 306, a given producer 302, a given commodity, and/or other factual or situational considerations.

In a like manner, such ascribed risks can also be applied to the terms of the contract 306, including terms such as price, time of delivery, and type of contract, for example. In certain embodiments, an ascribed risk applied to the commodity contract 306 may result in or determine the selection of a term or feature of the credit arrangement 318. Likewise, an ascribed risk applied to the credit arrangement 318 may result in or determine the selection of a term or feature of the contract 306.

In certain embodiments, the credit arrangements 318 can be associated with commodity contracts 306 on a corresponding one-to-one basis. The producer 302 may obtain multiple credit arrangements 318 through the buyer 304, subject to the number and type of contracts 306 in force, or planned for execution, between the producer 302 and the buyer 304. It can be seen that, for a give producer 302, each credit arrangement 318 may have a credit limit, interest rate, and/or other features which are different from or similar to the credit limit, interest rate, and/or other features of a separate credit arrangement 318 for that producer 302. In certain embodiments wherein multiple credit arrangements 318 are maintained for a given producer 302, the buyer 304 may establish an aggregate credit limit, for example, that is a function of all the multiple credit arrangements 318 of the producer 302. In addition, other features (e.g., an interest rate adjustment) or terms may be commonly or aggregatively applied in situations involving multiple credit arrangements 318. In certain embodiments, the producer 302 may establish multiple different contract 306 types each having independently ascribed risks. The maximum credit or credit limit extended to the producer 302 under the package may be an aggregate amount that is inversely related to an aggregate of each of the ascribed risks, or otherwise a function of the individual credit limits of credit arrangements 318 of the producer 302. At step 406, the application made by the producer 302 for the credit arrangement 318 can be subjected to an approval process. The approval process of step 406 may include a variety of standard credit approval activities or conducted by the buyer 304. The buyer 304 may also employ guidelines to determine eligibility of the producer 302 for the credit arrangement 318.

At step 408, if the producer 302 has been approved for the credit arrangement 318, then closing of the credit arrangement 318 may occur. In connection with approval, and prior to draws made against the credit arrangement 318, the producer 302 may be required to have one or more existing commodity contracts 306, and/or plans to enter into one or more commodity contracts 306, with the buyer 304. The value of the contracts 306 can serve as a basis for the amount or credit limit of the credit arrangement 318 extended to the producer 302 in association with the contracts 306. In various embodiments, the credit arrangements 318 can be established for a specific crop period (e.g., a crop year), and/or for a specific commodity (e.g., grain). The credit arrangements 318 can be established for different commodity years or other time periods (e.g., different crop years for a grain type commodity) and/or for different commodities. In certain situations, the Farm Service Agency (FSA) may be involved in association with offering the credit arrangement 318 to the producer 302.

In various embodiments, ownership of a note or other credit instrument associated with the credit arrangement 318 may be transferred upon closing to a credit arrangement purchasing entity 322. The credit arrangement purchasing entity 322 may be a third party loan buyer, for example, a guarantor, an underwriter, and/or any other suitable type of financial entity that can supply a source of funds under the credit arrangement 318. In certain embodiments, the buyer 304 and the purchasing entity 322 may be the same or substantially the same commercial entity.

In various embodiments, risk criteria applied by the buyer 304 for extending the credit arrangement 318 to the producer 302 may be selected so as to be no less stringent than the risk criteria applied by the credit arrangement purchasing entity 322 for extending the credit arrangement 318 to the producer 302. An advantage of this arrangement is found in the matching of risk criteria between the buyer 304 and the credit arrangement purchasing entity 322. This promotes a more seamless and efficient operation between the buyer 304 and the credit arrangement purchasing entity 322 in terms of avoiding potentially conflicting risk criteria in association with deciding how and under what terms to extend credit arrangements 318 to producers 302.

At step 410, the credit arrangement 318 can be serviced by the buyer 304, the credit arrangement purchasing entity 322, and/or the cooperative efforts of the entities 304, 322. During the life of the credit arrangement 318, the producer 302 may request funds or draw funds against the credit arrangement 318. In certain embodiments, use of funds derived from the credit arrangement 318 by the producer 302 is limited to agriculturally related purposes associated with the business needs of the producer 302. Funds may be disbursed to the producer 302 by electronic funds transfer (e.g., ACH), by check, and/or by any other suitable method or mechanism.

During the servicing stage, the buyer 304 may generate and communicate periodic statements (e.g., monthly statements) to the producer 302 that include balance information, interest rate changes, and/or other data, optionally on a contract-by-contract 306 basis, associated with the credit arrangement 318 or potentially multiple credit arrangements 318. It can be seen that the producer 302 may deal directly with the buyer 304 in receiving and sending communications about the credit arrangement 318.

In certain embodiments, the producer 302 may be permitted to reduce its financial liability under the credit arrangement 318 prior to settlement of the contract 306, such as by pre-payment of amounts borrowed under the credit arrangement 318. In various embodiments, amounts paid by the producer 302 to be applied against the credit arrangement 318 are received first by the buyer 304 and may then be passed along to the credit arrangement purchasing entity 322. If the producer 302 needs additional funds, it may be permitted to draw against the credit arrangement 318 up to the credit limit, so long as one or more commodity contracts 306 remain existing between the producer 302 and the buyer 304 at the time the funds are drawn. In certain embodiments, funds drawn by the producer 302 may be remitted directly to the producer 302 by the buyer 304, who may then in turn invoice the credit arrangement purchasing entity 322 to receive reimbursement for the amount remitted to the producer 302.

To assist in servicing multiple credit arrangements 318, the buyer 304 may employ a tracking system 332, such as a tracking system maintained by the credit arrangement purchasing entity 322, or any other suitably functional system that permits tracking and maintenance of multiple credit arrangements 318. For example, the tracking system 332 can be a computer system used as a management tool to track loan portfolios, make loan payoff calculations, make interest calculations, and/or perform other functions. In this manner, loan data can be communicated to the producer 302, such as in connection with periodic credit arrangement 318 statements sent to the producer 302. In certain embodiments, the purchasing entity 322 may be the entity that maintains the tracking system 332.

In association with settlement of the contract 306 at step 412, the buyer 304 may deduct the amount the producer 302 owes on the credit arrangement 318 against the amount the buyer 304 owes the producer 302 under the contract 306. Thus, at least a portion of the value of the products 308, 310, 312 delivered under the contract 306 may be applied to outstanding amounts owed under the credit arrangement 318. For example, the loan principal plus interest can be deducted from the proceeds owed to the producer 302 upon, or within a specified time after, settlement of the commodity contract 306. In addition, payments made at settlement at step 412 may account for any applicable discounts, expenses, and/or deductions, such as fees owed to the buyer 304 for providing biomass processing services 314 and/or biomass processing equipment 316 to the producer 302. For example, suppose that the producer 302 has an outstanding loan-type credit arrangement 318 for $25k on a 50,000 bushel corn storage contract 306, including all biomass byproducts 310 and biomass derivative products 312 generated from processing the corn. On December 1, the producer 302 prices and sells 5,000 bushels at $2.20 per bushel, resulting in gross revenue of $11k. After discounts and applicable deductions, the net proceeds are $10,200, which can be applied in its entirety against the principal and accrued interest associated with the $25k loan and/or the biomass processing service fee charged by the buyer 304. In connection with settlement of the contract 306, the buyer 304 may employ the above-mentioned tracking system 332 to assist with verification of settlement amounts. At step 414, any amounts due may be remitted to the credit arrangement purchasing entity 322, or generally to the owner of the note or instrument associated with the credit arrangement 318. It can be seen that the buyer 304 may collect credit arrangement 318 repayment amounts on behalf of the purchasing entity 322.

In various embodiments, the buyer 304 may employ a settlement system 334 to monitor relationships between the contracts 306 and the credit arrangements 318 and associated data. For example, the settlement system 334 can be a computer system used to update contracts 306 associated with credit arrangements 318 with a forward hold-payment date to prevent accidental full cash settlement under a given contract 306. By using the tracking system 332 and the settlement system 334 in concert, the buyer 304 can review credit arrangement 318 balances and prepare preliminary statements to arrive at the net proceeds to be applied against the credit arrangement 318 and amounts to be collected from the producer 302 at the time of settlement. The buyer 304 can enter a debit memo, for example, in its records for the amount of the collection, and then final settlement can be processed. In various embodiments, generation and entry of debit memos can be a manual and/or automated process, as known to those skilled in the art. Payments may be collected from the producer 302 prior to payment being made from the buyer 304 to the producer 302. In addition, collection amounts can be communicated and remitted to the purchasing entity 322, and the tracking system 332 can be updated to reflect various settlement transactions.

In certain situations, the buyer 304 may have a “bushels only” contract 306 option that commits bushels for a delivery period, allowing the producer 302 to establish a price up to the time of delivery. This type of contract 306 allows the producer 302 to designate a specific quantity of the agricultural product 308 or biomass related products 310, 312 during a specific delivery period to a specific location. For this type of contract 306, the buyer 304 may calculate an estimated value to create availability of funds for the producer 302 to borrow against the credit arrangement 318. This allows the buyer 304 to not force the producer 302 to apply a final price to the commodities 308, 310, 312. In the context of such contracts 306, the buyer 304 may permit borrowing against the credit arrangement 318 up to a predetermined percentage value of the contract 306, which may be in the range of 50% to 90% of the predetermined value, for example. If the contract 306 is for 10,000 bushels of grain and all biomass related products 310, 312 derived from the grain, for example, and if the combined grain and other products 310, 312 are valued at $20,000, then the buyer 304 may allow 80%, or $16,000, to be borrowed against the credit arrangement 318. It can be seen that because the value of the contract 306 can be variable based on an as yet undetermined price for the commodities 308, 310, 312, the percentage of the value applied may be subject to change based on a number of risk factors assessed by the buyer 304.

In various embodiments, the producer 302 remains obligated for repayment of the credit arrangement 318, such as if the amount of the contract 306 settlement is insufficient to cover all amounts owed under the credit arrangement 318. The buyer 304 may employ various safety mechanisms or thresholds that limit the amount of credit available under the credit arrangement 318 based on the type and characteristics of a given contract 306.

The above-described embodiments of the invention may be further combined with aspects of methods of trading commodities, financial transactions, programs, tools, structures and systems, examples of which are disclosed in the commonly assigned, pending U.S. patent application entitled, “Vendor Financial Credits in association with Commodity Contracts” filed on Oct. 9, 2006, Ser. No. 60/828,702, the entirety of which is incorporated herein by reference. Certain embodiments of the invention may provide a vehicle for producers to obtain and employ resources through marketing efforts and partnership relationships facilitated by a commodity buyer. In various embodiments, the invention may provide the producer with credits that can be applied to the purchase of goods and/or services needed by the producer.

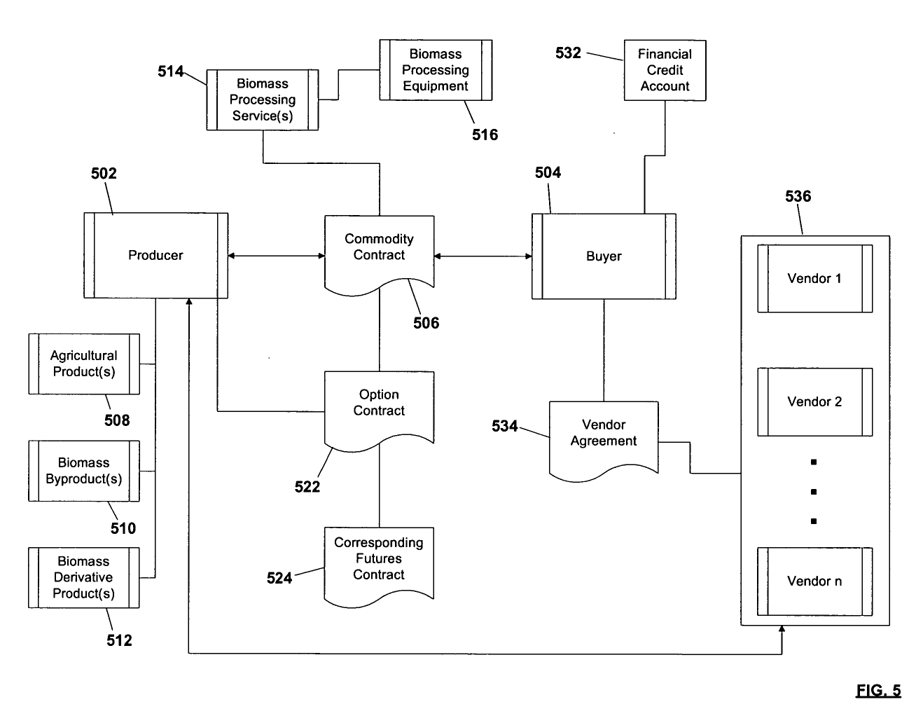

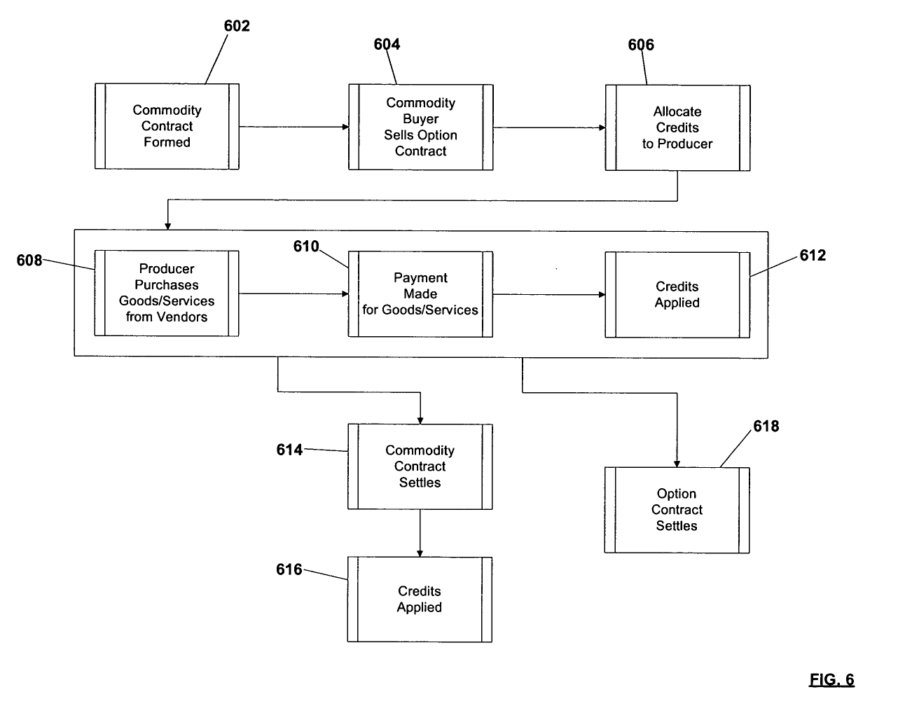

With reference to FIGS. 5 and 6, at step 602 a producer 502 enters into an arrangement or commodity contract 506 with a buyer 504 for production and delivery of an amount of agricultural products 508 and/or biomass related products 510, 512 in a future delivery period, and possibly at a price or prices. The contract 506 may include a cash commodity contract, for example, and/or may include an agreement for the buyer 504 to buy the products 508, 510, 512 from the producer 502 over one or more delivery periods. In addition, the contract 506 may include commitments by the buyer 504 to provide biomass processing services 514 and/or biomass processing equipment 516 to the producer 502 in exchange for a processing fee and/or a predetermined quantity or value of the products 508, 510, 512.

In certain embodiments, the basis offered to the producer 502 for at least a first one of the multiple delivery periods may be greater in comparison to a basis offered to the producer 502 for a commodity contract 506 covering a single delivery period. In various embodiments, the commodity contract 506 can include a floor value that establishes a minimum price at or above which the buyer 504 will purchase the commodities 508, 510, 512 from the producer 502.

At step 604, the buyer 504 may sell a short call option contract 522 for a corresponding futures contract 524 for the commodities 508, 510, 512 and realize a financial gain from the sale of the short call option 522. The short call option 522 may have a strike price based on a futures price of one or more of the commodities 508, 510, 512 and an expiration date, among other features known to those skilled in the art. The short call option 522 may be designed to expire prior to a delivery date of the commodity contract 506. On the expiration date of the option 522, the option 522 may expire because the market price of the commodities 508, 510, 512 on that date is less than or more than the strike price of the option 522. For example, if the market price is above the strike price of the option 522, then the option 522 expires and the buyer 504 is obligated for the difference between the market price and the strike price. This means that the holder or counterparty to the long call associated with the option 522 can exercise its rights to force the buyer 504 to sell the commodity 508, 510, 512 at the strike price of the option 522. The option 522 converts into the futures contract 524 upon expiration of the option 522.

Under the contract 506, the producer 502 agrees to sell the commodity 508, 510, 512 with a future component at no more than the strike price of the option 522, regardless of the market price on the expiration date of the option 522. Thus, the offsetting gain for the commodity buyer 504 in this arrangement is realized in the cash contract 506 formed with the producer 502. In other words, the producer 502 may be considered to be taking the upside risk of a short call. The arrangement provides for an immediate cash yield to the buyer 504, which amount of yield may also represent the best outcome that the producer 502 can expect. A risk of the producer 502 in entering into this arrangement is foregoing potential future gains for a guaranteed present financial gain (i.e., a certain amount of guaranteed credits that can be applied to the purchase of goods and/or services). Under the arrangement, the producer 502 is essentially able to convert time value into real value, by receiving actual monetary credit in present time versus realizing value on a specific date in the future.

In various embodiments, the commodity contract 506 includes a reference futures price or a price range in relation to the expiration date of the option 522 that can be used to determine the price at which the buyer 504 will purchase commodities 508, 510, 512 from the producer 502 under the contract 506. Also, the commodity contract 506 may include a reference futures price in relation to the expiration date of the option that can be used to determine a price or a price range the buyer 504 will purchase the commodity 508, 510, 512 from the producer 502 under the contract 506. In certain embodiments, the contract 506 may include a minimum price at which the buyer 504 will purchase commodities 508, 510, 512 from the producer 502.

It can be appreciated that embodiments of the invention are not limited to the buyer 504 selling the option 522. In general, any financial instrument, financial transaction, or other arrangement that provides financial gain to the buyer 504 may be employed. For example, the buyer 504 may realize volume discounts on purchases of substantial amounts of goods, products or other resources. These volume discounts may generate funds that can be passed on to the producers 502 in the form of credits allocated to a financial credit account 532. For example, the buyer 504 may be a large commercial entity that purchases relatively high volumes of steel for building commodity storage facilities. At least a portion of the volume discount realized by the buyer 504 from its steel supplier can be passed along to the producers 502 to allocate credits in the financial credit account 532. In addition, other alternatives for the option 522 include, for example and without limitation, derivatives, swaps, over-the-counter (OTC) trades, derivatives that use a market exchange as a bench mark but wherein the parties agree to non-exchange terms such as the expiration date of the option, or a strike price that is not an exchange-traded strike price. The buyer 504 may enter into such arrangements with a suitable counterparty, such as an investment bank or another similar type of financial institution. In various embodiments, a short futures position underlies the position of the option 522, or other arrangement, to beneficially hedge the purchase of agricultural type commodities, for example, or other types of commodities that may be subject to seasonal harvesting conditions.

At step 606, one or more financial credits may be allocated for the benefit of the producer 502 in the financial credit account 532 in an amount based on at least a portion of the financial gain realized from the sale of the option 522. As described below, the financial credits allocated to the producer 502 may be used by the producer 502 to purchase various goods and/or services. The allocated credits may be provided to the producer 502 for a set term and may or may not expire if not used by the producer 502 prior to expiration of the term. In various embodiments, a fee or service charge may be charged by the buyer 504 to the producer 502 for forming the contract 506 and allocating the credits to the financial credit account 532. The allocated credits may be calculated as the financial gain realized by sale of the option 522 by the buyer 504 less the amount of the fee charged by the buyer 504. In various embodiments, allocating financial credits on behalf of the producer 502 can be made in an amount corresponding to an amount gained by the commodity buyer 504 from trading in the commodities 508, 510, 512 in a market.

In various embodiments, the buyer 504 may establish an agreement 534 with one or more vendors 536 of goods and/or services. Under the agreement 534, the vendors 536 can accept payment from the buyer 504 to offset debt owed by the producer 502 to one or more of the vendors 536 for purchasing goods and/or services from the vendors 536. In certain embodiments, the goods or services eligible for purchase in accordance with the agreement 534 may be limited to those used for agriculturally related purposes and/or for a purpose related to producing the commodity. When the producer 502 purchases goods and/or services from one or more of the vendors 536 at step 608, a payment may be applied at step 610 on behalf of the producer 502 by the buyer 504 to the appropriate vendor or vendors 536. At step 612, credits allocated in the financial credit account 532 may be applied or factored into the payment made at step 610.

In various embodiments, the payment made by the buyer 504 to the vendor 536 may be in an amount up to the financial credits allocated to the producer 502 in the financial credit account 532. Payments made to the vendors 536 may also be used to offset one or more product or service discounts offered by the various vendors 536 to the producer 502. In certain embodiments, the payment made to the vendor 536 may establish a predetermined discount for a given product or service offered by the vendor 536 receiving the payment. If the producer 502 elects to purchase goods and/or services from one of the vendors 536, payments may be made in amounts at least up to the amount of financial credits allocated on behalf of the producer 502.

The vendors 536 may include a plurality of different vendors 536 formed and established under the agreement 534 as a set of alliance partners. In this alliance arrangement, the vendors 536 partner with the buyer 504 to allow the producer 502 to obtain goods or services by use of the allocated credits in the financial credit account 532. It can be seen that a benefit of the invention offers potentially enhanced purchasing power to the producers 502 to obtain and employ goods and/or services needed to maintain commercially viable business enterprises. In certain embodiments, a vendor 536 may be an affiliate of the buyer 504, or the buyer 504 itself. Also, the vendor 536 may be an independent third party not affiliated with the buyer 504. The designated vendors 536 may have each agreed to accept from the buyer 504 at least partial payment of debt incurred by the producer 502, such as for debt incurred in association with delivery of commodities 508, 510, 512 under the commodity contract 506.

At step 614, the commodity contract 506 between the buyer 504 and the producer 502 can be settled. Settlement of the contract 506 may involve applying or allocating one or more credits in the financial credit account 532 to the producer 502 on or after settlement at step 616. In various embodiments, the option contract 522 can be settled at step 618 by the buyer 504 on its expiration date by entering the futures contract 524 to buy a corresponding amount of the commodities 508, 510, 512 associated with the contract 506 at the futures price current on the date of expiration; by buying an offsetting options contract; or, by doing nothing while allowing the option 522 to expire.

In various embodiments, the credits allocated to the producer 502 can be used to pay for at least a portion of the biomass processing services 514 and/or the biomass processing equipment 516 used or accessed by the producer 502. In addition, one of the vendors 536 or alliance partners may be a biomass processing service provider who offers such services 514 or equipment 516 for use by the producer 502.

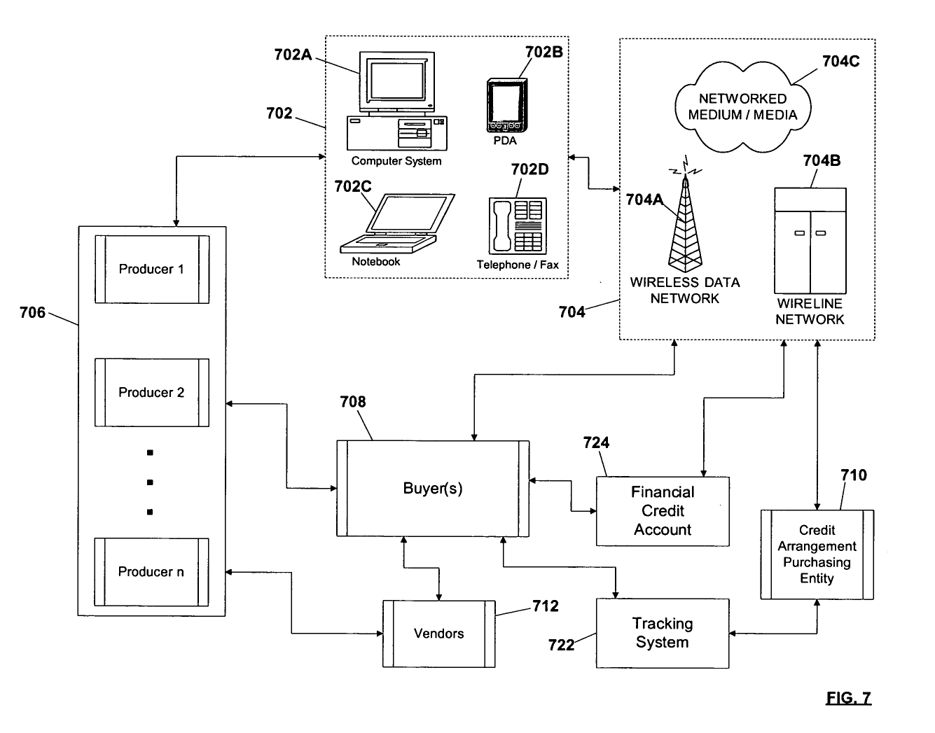

With reference to FIG. 7, the various entities and/or systems described herein may communicate between/among each other with various access devices 702 through various communication media 704. Examples of access devices 702 include, without limitation, computer systems 702A, wireless devices 702B (e.g., personal data devices), notebook computer systems 702C, and/or telephone or fax 702D devices. Examples of communication media 704 include, without limitation, wireless data networks 704A, wireline networks 704B, and/or various networked media 704C (e.g., intranets or the Internet). It can be seen that various data, documents, and/or financial transactions can be communicated between/among entities such as producers 706, buyers 708, credit arrangement purchasing entities 710, and/or vendors 712. In addition, access to the different systems described above, such as a tracking system 722 and/or a financial credit account 724 may be facilitated by use of the access devices 702 in connection with the communication media 704.

As used herein, a “computer” or “computer system” may be, for example and without limitation, either alone or in combination, a personal computer (PC), server-based computer, main frame, server, microcomputer, minicomputer, laptop, personal data assistant (PDA), cellular phone, pager, processor, including wireless and/or wireline varieties thereof, and/or any other computerized device capable of configuration for receiving, storing and/or processing data for standalone application and/or over a networked medium or media.

Computers and computer systems described herein may include operatively associated computer-readable media such as memory for storing software applications used in obtaining, processing, storing and/or communicating data. It can be appreciated that such memory can be internal, external, remote or local with respect to its operatively associated computer or computer system. Memory may also include any means for storing software or other instructions including, for example and without limitation, a hard disk, an optical disk, floppy disk, DVD, compact disc, memory stick, ROM (read only memory), RAM (random, access memory), PROM (programmable ROM), EEPROM (extended erasable PROM), and/or other like computer-readable media.

In general, computer-readable media may include any medium capable of being a carrier for an electronic signal representative of data stored, communicated or processed in accordance with embodiments of the present invention. Where applicable, method steps described herein may be embodied or executed as instructions stored on a computer-readable medium or media.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein. It should be appreciated that the figures are presented for illustrative purposes and not as construction drawings. Omitted details and modifications or alternative embodiments are within the purview of persons of ordinary skill in the art.

It can be appreciated that, in certain aspects of the present invention, a single component may be replaced by multiple components, and multiple components may be replaced by a single component, to provide an element or structure or to perform a given function or functions. Except where such substitution would not be operative to practice certain embodiments of the present invention, such substitution is considered within the scope of the present invention.

The examples presented herein are intended to illustrate potential and specific implementations of the present invention. It can be appreciated that the examples are intended primarily for purposes of illustration of the invention for those skilled in the art. The diagrams depicted herein are provided by way of example. There may be variations to these diagrams or the operations described herein without departing from the spirit of the invention. For instance, in certain cases, method steps or operations may be performed or executed in differing order, or operations may be added, deleted or modified.

Furthermore, whereas particular embodiments of the invention have been described herein for the purpose of illustrating the invention and not for the purpose of limiting the same, it will be appreciated by those of ordinary skill in the art that numerous variations of the details, materials and arrangement of elements, steps, structures, and/or parts may be made within the principle and scope of the invention without departing from the invention as described herein.

What is claimed is:

1. A method comprising:
offering a biomass processing service to a producer of an agricultural product;
in exchange for offering the biomass processing service, receiving a promise from the producer to pay a fee for performing the biomass processing service, at least a portion of the biomass processing service fee to be paid by delivery of at least one of:
a quantity of the agricultural product,
a quantity of a biomass byproduct derived from the agricultural product, or
a quantity of a biomass derivative product derived from the agricultural product or the biomass byproduct.

2. The method of claim 1, further comprising the portion of the biomass processing service fee to be paid by delivery of at least one of:
a quantity and quality of the agricultural product,
a quantity and quality of a biomass byproduct derived from the agricultural product, or
a quantity and quality of a biomass derivative product derived from the agricultural product or the biomass byproduct.

3. The method of claim 1, wherein the biomass processing service includes transporting at least one of the biomass byproduct or the biomass derivative product from a production site to a collection site.

4. The method of claim 1, wherein the biomass processing service includes combining at least one of the biomass byproduct or the biomass derivative product.

5. The method of claim 1, wherein the biomass processing service includes chemical or thermal conversion of a biomass related product to produce a gas, liquid, or solid product.

6. The method of claim 1, wherein the biomass processing service includes chemical or thermal conversion of at least one of the biomass byproduct or the biomass derivative product.

7. The method of claim 1, wherein the biomass processing service includes pelletizing at least one of the biomass byproduct or the biomass derivative product.

8. The method of claim 1, wherein the biomass processing service includes shredding at least one of the biomass byproduct or the biomass derivative product.

9. The method of claim 1, wherein the biomass processing service includes hydrothermally processing at least one of the biomass byproduct or the biomass derivative product.

10. The method of claim 1, wherein the biomass processing service includes refining at least one of the biomass byproduct or the biomass derivative product.

11. The method of claim 1, wherein the biomass processing service includes baling at least one of the biomass byproduct or the biomass derivative product.

12. The method of claim 1, wherein the biomass processing service includes storing at least one of the biomass byproduct or the biomass derivative product.

13. The method of claim 1, wherein the biomass processing service includes providing access to a piece of biomass processing equipment to the producer.

14. The method of claim 13, wherein the biomass processing equipment includes at least one of a transporter, a pyrolysis unit, a combine, a gasifying unit, a burner, a combustor, a pelletizer, a shredder, a hydrothermal processor, a refinery, a hydrocracker, a baler, or a storage tank.

15. The method of claim 13, wherein the biomass processing equipment includes mobile equipment.

16. The method of claim 1, wherein the biomass processing service fee includes a fee associated with use of or access to biomass processing equipment by the producer.

17. The method of claim 1, wherein the biomass derivative product includes at least one of pyrolysis oil, synthetic gas, methane gas, hydrogen gas, mixed alcohol, ethanol, propanol, butanol, pentanol, wax, green diesel, olefins, propylene, ethylene, green gasoline, C3 carbon chain chemicals, aldehydes, formaldehyde, MTBE, acetic acid, methanol, polyols, tar, or biomass-containing animal feed.

18. The method of claim 1, further comprising receiving delivery of one or more of the agricultural product, the biomass byproduct, or the biomass derivative product at a predetermined time and location.

19. The method of claim 18, further comprising pricing at least one of the delivered agricultural product, the delivered biomass byproduct, or the delivered biomass derivative product at a local market price.

20. The method of claim 18, further comprising pricing at least one of the delivered agricultural product, the delivered biomass byproduct, or the delivered biomass derivative product using at least one of an energy market index or a futures price.

21. The method of claim 1, further comprising paying the producer for delivery of the agricultural product, the biomass byproduct, or the biomass derivative product, wherein the payment to the producer includes a discount applied to the biomass processing service fee.

22. The method of claim 1, further comprising paying the producer for delivery of only the agricultural product, and accepting a predetermined extra quantity of agricultural product in lieu of delivery of the biomass byproduct or the biomass derivative product.

23. The method of claim 1, further comprising paying the producer for delivery of the agricultural product, the biomass byproduct, or the biomass derivative product, wherein at least a portion of the payment to the producer includes at least one bartered good.

24. The method of claim 23, wherein the bartered good includes at least one of an agricultural product, food, energy, loan interest rate reduction, loan payment reduction, loan principal balance reduction, greenhouse gas credit, grain basis, or energy basis.

25. A method comprising:
offering a biomass processing service to a producer of an agricultural product;
in exchange for offering the biomass processing service, receiving a promise from the producer to deliver at least one of:
a quantity of the agricultural product,
a quantity of a biomass byproduct derived from the agricultural product, or
a quantity of a biomass derivative product derived from the biomass byproduct; and,
offering a credit arrangement to the producer in association with offering the biomass processing service, wherein use of the credit arrangement by the producer is limited to agriculturally related purposes.

26. The method of claim 25, further comprising receiving a promise from the producer to deliver at least one of:
a quantity and quality of the agricultural product,
a quantity and quality of a biomass byproduct derived from the agricultural product, or
a quantity and quality of a biomass derivative product derived from the agricultural product or the biomass byproduct.

27. A method of trading agricultural products and biomass related products, the method comprising:
offering a contract to a producer from a buyer to purchase at least one biomass related product at a price and for delivery of the products at a future delivery date; and
offering a credit arrangement to the producer with terms providing for repayment of debt against the credit arrangement to be paid to the buyer being linked to settlement of the contract.

28. A method for facilitating a commodity contract between a producer and a buyer, the commodity contract being for delivery of a commodity at a price at a future date, the method comprising:
establishing a credit arrangement for the producer, a credit limit of the credit arrangement being a function of the value of the commodity contract, wherein at least one commodity under the contract includes a biomass related product;
permitting the producer to draw funds against the credit limit; and,
wherein the credit arrangement requires payment by the producer in association with settlement of the commodity contract for at least a portion of amounts drawn against the credit limit of the credit arrangement.

29. A method of trading a commodity, the method comprising:
forming a cash commodity contract between a producer and a commodity buyer for purchase of a commodity to be delivered in a future delivery period, wherein the commodity includes at least one biomass related product;
selling a short call option contract for a corresponding futures contract for the commodity and realizing a financial gain from the sale of the option;
allocating a financial credit for the benefit of the producer in an amount based on the financial gain realized from sale of the option;
establishing an agreement with a vendor of at least one of goods and services to the producer to accept payment from the commodity buyer to offset a debt owed by the producer to the vendor for purchasing the goods or services from the vendor, provided that the goods or services are for an agricultural purpose;
if the producer purchases the goods or services from the vendor, applying a payment on behalf of the producer by the buyer to the vendor, in an amount at least up to the credits allocated for the producer.

30. The method of claim 29, wherein the vendor includes a biomass service provider.

31. The method of claim 29, further comprising establishing the agreement with a plurality of different vendors to form a set of alliance partners with the commodity buyer from which the producer can obtain goods or services by use of the allocated credits.

32. The method of claim 29, wherein the commodity contract comprises an agreement to buy the commodity from the producer over multiple delivery periods and a basis offered to the producer for at least a first one of the multiple delivery periods that is greater than a basis offered to the producer for a commodity contract covering a single delivery period.

33. The method of claim 29, wherein the commodity contract includes a reference futures price range in relation to the expiration date of the option used to determine a price the commodity buyer will purchase the commodity from the producer.

34. The method of claim 29, wherein the option contract is settled by the commodity buyer on the expiration date by at least one of:
entering a futures contract to buy a corresponding amount of the commodity at the futures price current on the date of expiration for the delivery period;
buying an offsetting options contract; or
doing nothing while allowing the option to expire.
